(19) United States
(12) Patent Application Publication
(10) Pub. No.: US 2015/0315421 A1
(43) Pub. Date: Nov. 5, 2015

(54) AUXILIARY ADHESIVE TAPE FOR A REMOVABLE ADHESIVE FILM

(71) Applicant: TESA SE, Hamburg (DE)

(72) Inventors: THORSTEN KRAWINKEL, Hamburg (DE); MARJI SMITH, Sunnyvale, CA (US)

(73) Assignee: TESA SE, Hamburg (DE)

(21) Appl. No.: 14/700,448

(22) Filed: Apr. 30, 2015

Related U.S. Application Data
(60) Provisional application No. 61/986,186, filed on Apr. 30, 2014.

(51) Int. Cl. C09J 7/02; B32B 43/00; B32B 7/06; B32B 38/10

(52) U.S. Cl. CPC C09J 7/0285; B32B 38/10; B32B 43/006; B32B 7/06; C09J 7/0275; B32B 2323/04; B32B 2327/18; B32B 2307/538; B32B 2457/00; C09J 2433/00; C09J 2423/046; C09J 2467/006; C09J 2201/128; C09J 2201/122; C09J 2205/302; C09J 2203/326

(57) ABSTRACT

A auxiliary adhesive tape is used as a removal aid for removing an elastic, double-sided adhesive film which can be removed, without leaving any residue or causing any destruction, by means of stretching and elongation in the bond plane, wherein said adhesive film has at least one end which is designed as a catch, wherein an object is attached by means of the same, and the same works by means of being pulled at a removal angle of >45° around an edge of the attached object. The auxiliary adhesive tape in this case is adhered around this edge and is a single-sided adhesive tape having a carrier, wherein the carrier satisfies at least one of the two properties below:
a) the carrier consists of a low-energy polymer,
b) the carrier has a structured surface.

This patent application claims priority of U.S. Provisional Patent Application No. 61/986,186 filed on Apr. 30, 2014, the entire contents of which is incorporated herein by reference.

The invention relates a removal aid for removing an elastic, double-sided adhesive film which can be removed, without leaving any residue or causing any destruction, by means of stretching and elongation in the bond plane, wherein said adhesive film has at least one end which is designed as a catch, wherein an object is attached by means of the same, and wherein the same works by means of being pulled at a removal angle of >45° around an edge of the attached object, and to an adhesive film adapted for this purpose.

Elastic or plastically highly extensible self-adhesive tapes or films which can be removed by means of elastic stretching in the bond plane without leaving any residue or causing any destruction are known from U.S. Pat. No. 4,024,312 A, DE 33 31 016 C2, WO 92/11332 A¹, WO 92/11333 A¹, DE 42 22 849 C1, WO 95/06691 A¹, DE 195 31 696 A1, DE 196 26 870 A1, DE 196 49 727 A1, DE 196 49 728 A1, DE 196 49 729 A1, DE 197 08 364 A1, DE 197 20 145 A1, DE 198 20 858 A1, WO 99/37729 A1, and DE 100 03 318 A1, by way of example, and are also termed strippable self-adhesive tapes below.

Such strippable self-adhesive tapes are frequently used in the form of single- or double-sided adhesive film strips which preferably comprise a non-adhesive handling region where the removal process is initiated. Self-adhesive tapes corresponding to special applications are found in DE 42 33 872 C1, DE 195 11 288 C1, U.S. Pat. No. 5,507,464 B1, U.S. Pat. No. 5,672,402 B1, and WO 94/21157 A1, among other places. Special designs are also described in DE 44 28 587 C1, DE 44 31 914 C1, WO 97/07172 A1, DE 196 27 400 A1, WO 98/03601 A1 and DE 196 49 636 A1, DE 197 20 526 A1, DE 197 23 177 A1, DE 197 23 198 A1, DE 197 26 375 A1, DE 197 56 084 C1, DE 197 56 816 A1, DE 198 42 864 A1, DE 198 42 865 A1, WO 99/31193 A1, WO 99/37729 A1, WO 99/63018 A1, WO 00/12644 A1, and DE 199 38 693 A1.

Preferred applications of the strippable adhesive tapes named above particularly include the fixation of light to moderately heavy objects in residential, work, and offices areas, without leaving any residue or causing any destruction. For applications in residential and office areas, quite thick products of over 400 μm are generally used.

In the consumer electronics industry—such as in the production of mobile telephones, digital cameras, or laptops, for example—there is an ever-growing desire for the possibility of separating individual components during the disposal thereof following their use. As a result of such separation, some of the components can be re-used or processed. Or, at the very least, separate disposal is possible. For this reason, removable adhesive bonds are of great interest in this industry. In particular, adhesive tapes which possess high holding power and can be easily removed when desired constitute a reasonable alternative in this case to adhesive tapes which must first be pre-treated prior to their removal, by means of heating, for example.

An easily removable adhesive bond is also desirable in the assembly process, in order to make it possible to remove, and re-align and attach, components which are incorrectly attached or aligned, rather than throwing away the entire component as waste. An example of this are batteries in mobile telephones which are inserted towards the end of the manufacturing process. If the battery is not properly positioned at the right point in the right orientation, the device cannot be used. If it is not possible to re-arrange the battery, the entire device would need to be thrown away, including the perhaps expensive components which have already been assembled, such as the display, for example. The possibility of re-positioning the battery would therefore lead to a reduction in waste and to significant savings.

In addition, the removability of certain components in the consumer electronics industry is desirable as a way of making it possible to exchange defective components in a simple manner. As such, the batteries in mobile telephones or digital cameras, for example, are increasingly adhered in the device. The charging of such batteries occurs in the device. If, however, at this point a battery must be exchanged as a result of a defect, it is necessary to detach the adhesive bond.

In the consumer electronics industry, adhesive tapes which are as thin as possible are preferred, because the end devices should be as thin as possible, and therefore all individual components should also require little space.

The removal of the adhesive tapes in this case ideally occurs by means of stretching of the adhesive tape in the bond plane, because the adhesive force lessens as the angle between the bond surface and the direction of stretching becomes smaller. Because, however, the individual components in the consumer electronics devices frequently are positioned very close to each other, there is frequently not sufficient room for stretching the adhesive tapes. As a result, the stretching can only occur at a larger angle to the bond surface. In the worst case, the stretching is only possible at a 90° angle or even a greater angle.

However, when removal occurs at a greater angle, the force required increases significantly.

When very thin strippable adhesive tapes which are removed without a carrier are used, tearing occurs more often. If the adhesive strips tear, it is generally no longer possible to remove them, because the residue of the adhesive strip pulls back into the gap of the bond, and there is no longer a catch available.

In the case of adhesives which have such a high resistance to tearing that they do not tear, it is frequently observed that the forces become so high at an angle of 90° that the tape cannot stretch any further. In this case, removal is likewise impossible.

The design of the edge of the adhered object, around which the removal is carried out, can contribute to a solution in this case. Such a solution is described in DE 197 29 706 for hooks in the consumer field. The edge in this case is made of a select material which possesses the least possible static and dynamic friction—such as polyethylene, for example. However, it is very difficult to equip the edge of a component—such as a battery, for example—with such an edge.

In addition, it appears very difficult to modify the individual components, such as batteries, for example, in such a manner that they comprise an edge made of a material with lower dynamic friction. In addition, such a modification is not always possible because the components and the materials from which they are made must comply with numerous additional requirements.

Therefore, the problem addressed by the invention is that of removing an adhesive film which is attached in such a manner that its removal makes it necessary to stretch the same at a removal angle of up to 135°, and particularly up to 90°, to reduce the tendency to produce tears, and also to reliably ensure complete removability of the adhesive film at such a pulling angle.

This problem is addressed according to the invention in that an auxiliary adhesive tape is used as the removal aid named above, wherein the auxiliary adhesive tape is adhered around the edge of the object being attached, wherein the removal occurs around said edge. The auxiliary adhesive tape in this case is a single-sided adhesive tape having a carrier, wherein the carrier satisfies at least one of the two properties below:
a) the carrier consists of a low-energy polymer,
b) the carrier has a structured surface.

It has been surprisingly demonstrated that the number of tears is smaller, when the removal occurs around an edge at a large removal angle, as a result of an adhesive tape which has a reverse side made of a low-energy polymer and/or which has a structured reverse side being attached around the edge, compared to a configuration without the corresponding adhesive tape. It is additionally surprising that the auxiliary adhesive tape is not likewise removed during the removal process of the adhesive tape which can be removed by stretching and elongation—even if the adhesive force of the auxiliary adhesive tape is relatively low.

In the context of the invention, low-energy′ means a surface tension <40 mN/m. The surface tension in this case is determined by means of ethanol test ink. The test ink is available in surface tensions of different values increasing by double steps. First, an ink with high surface tension is applied continuously to the surface. If the edges of the brush strokes are stable for two seconds, the surface is easily wettable. The surface tension of the substrate then corresponds at least to the value of the test ink. If the edges of the brush strokes of the test ink run together, then the process is continued with the next lower test ink. In this way, the value of the surface tension of the material is approached in a stepwise fashion. The surface tension of the material corresponds to the value of the last test ink which wetted the surface for at least 2 seconds.

In the context of the invention, the ‘removal angle’ should be understood to mean the angle that the catch creates with respect to the bond plane when pulled. The removal angle in the present invention is preferably between 45° and 90°, and particularly between 60° and 90°, and it is particularly preferably 90°—meaning that the removal occurs perpendicularly to the bond plane.

The term ‘adhesive film’ in the context of the invention hereby also expressly includes adhesive tapes which only differ from adhesive films with respect to their elongation—meaning the ratio of the length to the width thereof.

The present invention is suitable for all double-sided extensible adhesive films which can be removed by means of stretching and elongation in the bond plane without leaving any residue or causing any destruction. In particular, the adhesive film has a double-sided adhesive design.

As the adhesive films, such adhesive films can be used which possess an extensible carrier which is responsible for the resistance to tearing, as well as those which only consist of an adhesive.

The catch of the adhesive film is an end region of the adhesive film which is not adhesive. Such a region can be created—in the case of an adhesive film which is formed by the application of adhesive to both sides of an extensible carrier—by no adhesive being applied in one region, or—in the case of an adhesive film, regardless of whether the same has a carrier or not—by both adhesive surfaces being covered by a covering, wherein the side of the covering which faces outward is not itself adhesive. An adhesive film can have multiple catches. However, it preferably has exactly one catch. The catch in this case is arranged in the direction of stretching of the adhesive film.

Polyethylene films such as HDPE, LDPE, or copolymers with polypropylene, can be considered for the carrier which is based on a low-energy polymer, for the auxiliary adhesive tape being used, the same being adhered around the corner. However, films based on fluorinated polymers such as polytetrafluoroethylene or polyvinylchloride can also be used.

Structured carriers can also include other plastics, such as, by way of example, polyethylene terephthalate (PET) or polypropylene (PP)—to name only a few examples. The structuring in this case can be performed both by stamping and by etching the surface. The structuring can have the form of grooves or diamonds, by way of example. The structuring can also be random, as is the case in etching processes. The average roughness value of the structuring Ra must have a value greater than 0.5 μm in this case, if the value is recorded according to DIN EN ISO 4287:2010. The average roughness value is preferably greater than 0.8 μm, and particularly preferably greater than 1 μm.

The single-sided auxiliary adhesive tape according to the invention, having a carrier based on a low-energy or structured plastic, is adhered around the edge of the object, wherein the adhesive film will be pulled out around said edge. In this case, the auxiliary adhesive tape is adhered before the adhesive film is applied.

The problem addressed by the invention is also solved by a multi-layer adhesive film which has the following layers:

a) an extensible, double-sided adhesive film which can be removed without leaving any residue or causing any destruction, having at least one end which is designed as a catch,

b) a single-sided auxiliary adhesive tape, the carrier of which satisfies at least one of the two properties below:
i) the carrier consists of a low-energy polymer,
ii) the carrier has a structured surface,

wherein the auxiliary adhesive tape, proceeding from the region adjacent to the catch, at least partially covers the removable adhesive film, as well as at least partially covers the catch, wherein the non-adhesive carrier side of the auxiliary adhesive tape faces the removable adhesive film and the catch.

In the region of the catch, the auxiliary adhesive tape is not bonded adhesively to the catch, because two non-adhesive surfaces meet each other at this point. This is because, by definition, the catch has a non-adhesive design, and the auxiliary adhesive tape is attached to the object being attached by means of its adhesive side. For this reason, the auxiliary adhesive tape and the catch merely lie on each other in the region of the catch.

If such a multi-layer adhesive film is used, only a single adhering step is needed because the auxiliary adhesive tape and the removable adhesive tape are bonded to each other, such that they are together adhered to the object being attached.

As the extensible, double-sided adhesive film, the adhesive films indicated above as strippable adhesive tapes can be used. These are described, by way of example, in the documents listed above in the introduction.

The auxiliary adhesive tape preferably extends over the entire width of the double-sided adhesive film, because an even pulling-out is ensured in this manner.

The auxiliary adhesive tape can extend over the entire length of the adhesive region of the adhesive film. However, the auxiliary adhesive tape preferably only extends, proceeding from the catch, over a part of the removable adhesive film in the longitudinal direction thereof. It is likewise particularly advantageous if the auxiliary adhesive tape also extends, proceeding from the adhesive region, over a part of the catch.

In this case, the longitudinal direction is the direction in which the stretching occurs.

Many areas of application of the present invention can be contemplated and are possible. The present invention is particularly suitable for the consumer electronics industry. ‘Consumer electronics’ in this case means electronic devices in the fields of entertainment, communication, and office. The present invention is particularly suitable for use in manufacturing, particularly the industrial manufacturing of devices for this field.

Several devices are listed below, wherein the invention can be used in an advantageous manner in the manufacturing processes of these devices. However, the specifically listed representative devices in this list are not intended to unnecessarily restrict the object of the invention.
photographic devices, digital cameras, photography accessories (such as light meters, flash bulb devices, apertures, camera housings, lenses, etc.), film cameras, video cameras
microcomputers (mobile computers, pocket computers, pocket calculators), laptops, notebooks, netbooks, ultrabooks, tablet computers, handhelds, electronic calendars and organizers (so-called “electronic organizers” or “personal digital assistants”, PDA, Palmtops), modems,
computer accessories and operating devices for electronic devices, such as mice, keypads, graph tablets, microphones, loudspeakers, game consoles, game pads, remote controllers, remote controls, touchpads
monitors, displays, display screens, touch-sensitive displays (touchscreen devices), projectors
reading devices for electronics books (e-books)
small television devices, pocket televisions, film playback devices, video playback devices
radios (as well as mini- and pocket radio devices), Walkmen, Discmen, music playback devices for, by way of example, CD, DVD, Blueray, cassette tapes, USB, MP3, headphones
wireless telephones, mobile telephones, smartphones, wireless speaking systems, hands-free speaking devices, personal call devices (pagers, beepers)
mobile defibrillators, blood sugar meters, blood pressure meters, pedometers, pulse meters
flashlights, laser pointers
mobile detectors, optical enlarging devices, telescopes, night vision devices
GPS devices, navigation devices, portable interface devices for satellite communication
data storage devices (USB sticks, external hard drives, memory cards)
wrist watches, digital watches, pocket watches, chain watches, stop watches.

### BRIEF DESCRIPTION OF THE DRAWINGS

FIG. 1 shows the cross-section of two components which are attached to a base. In this case, the component 10 being removed is bonded to a base 30 by means of an adhesive strip 40 which can be removed by pulling. Because of the neighboring component 20, the adhesive strip is unable to stretch in the bond plane. For this reason, removal is only possible at a large angle around the edge of the component 40. The removal takes place, in the image, upward, in the direction of the arrow.

FIG. 2 shows the construction as in FIG. 1, having the components 10 and 20, and the adhesive tape 40 which can be removed by stretching. However, in this case, a single-sided adhesive tape having a carrier based on a low-energy polymer and/or a structured polymer is glued around the edge of the component being removed. The removal at this point occurs around the newly-created edge, and not around the original edge of the component 10, thereby reducing the influence of the edge of the component.

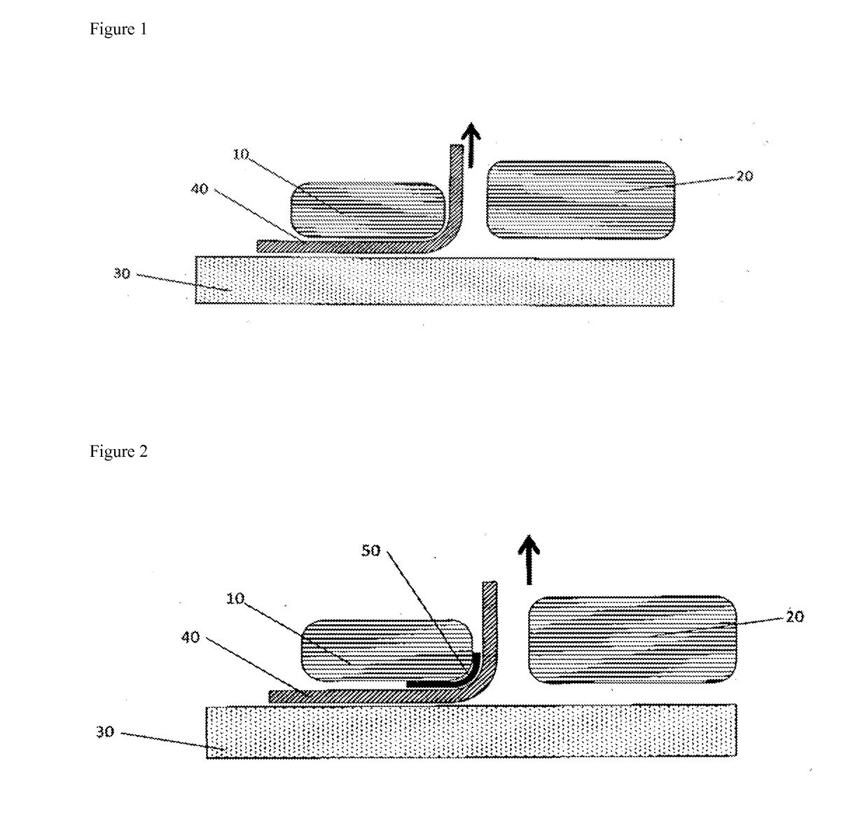

### EXAMPLES

A sample body made of polystyrene and having an edge with a radius of 3 mm is adhered to an aluminum plate using tesa 70420—a single-layer adhesive tape with a 200 μm thickness. The adhesive tape has a width of 15 mm and a bonding length of 40 mm. The catch region of the adhesive tape, which projects out of the bond joint, is 30 mm long.

The removal of the adhesive strip takes place at an angle of 90° with respect to the bond surface, at a speed of 1000 mm/min.

At this point, two different tapes are used, and are adhered around the edge of the polystyrene, wherein the removal will occur around said edge. First, an adhesive tape with an acrylate adhesive and a carrier made of HDPE is used. Second, an adhesive tape with an acrylate adhesive and an etched PET carrier with an average roughness of 1 μm is used.

Ten experiments are made with each removal aid, and in the process the number of adhesive strips which tear upon removal, and the force required for the removal, is recorded.

| | | Number of tears in |
|---|---|---|
| Example No. | Design of the edge | 10 experiments |
| 1 | No variation | 3 |
| 2 | With PE adhesive tape | 1 |
| 3 | With etched PET carrier | 1 |

As can be seen in the table, the tendency to form tears drops very significantly in the use according to the invention.

1. A method for facilitating the removal of an elastic, double-sided adhesive film from an object to which said adhesive film has been attached, wherein said adhesive film is of a type that can be removed, without leaving any residue or causing any destruction, by means of stretching and elongation in the bond plane, and wherein said adhesive film has at least one end which is designed as a catch, said method comprising adhering an auxiliary adhesive tape between said catch of said adhesive film and an edge of said object to facilitate removal of said adhesive film from said object even when said adhesive film is pulled at a removal angle of >45° around said edge of said object, wherein the auxiliary adhesive tape is a single-sided adhesive tape having a carrier, wherein the carrier satisfies at least one of the two properties below:
a) the carrier consists of a low-energy polymer; and
b) the carrier has a structured surface.

2. The method according to claim 1, wherein the carrier consists of polyethylene or polytetrafluoroethylene.

3. The method according to claim 1, wherein the carrier consists of a polymer with a surface having a structure with an average roughness value Ra greater than 0.5 μm.

4. The method according to claim 1, wherein the object is an electronics component.

5. A multi-layer adhesive film having the following layers:
a) an extensible, double-sided adhesive film which can be removed without leaving any residue or causing any destruction, having at least one end which is designed as a catch; and
b) a single-sided auxiliary adhesive tape, the carrier of which satisfies at least one of the two properties below:
i) the carrier consists of a low-energy polymer; and
ii) the carrier has a structured surface;
wherein the auxiliary adhesive tape, proceeding from a region adjacent to the catch, at least partially covers the removable adhesive film, as well as at least partially covers the catch, and wherein a non-adhesive carrier side of the auxiliary adhesive tape faces the removable adhesive film and the catch.

6. A multi-layer adhesive film according to claim 5, wherein the auxiliary adhesive tape extends over the entire width of the double-sided adhesive film.

7. A multi-layer adhesive film according to claim 5, wherein the auxiliary adhesive tape only extends, proceeding from the catch, over a part of the removable adhesive film in the longitudinal direction thereof, and also, proceeding from the adhesive region, only over a part of the catch.

8. A method of attaching an object to a substrate and thereafter removing the object from the substrate, said method comprising: (A) attaching the object to the substrate by bonding to an elastic, double-sided adhesive film, wherein said adhesive film is of a type that can be removed, without leaving any residue or causing any destruction, by means of stretching and elongation in the bond plane, and wherein said adhesive film has at least one end which is designed as a catch, said bonding further comprising adhering an auxiliary adhesive tape between said catch of said adhesive film and an edge of said object, wherein the auxiliary adhesive tape is a single-sided adhesive tape having a carrier, wherein the carrier satisfies at least one of the two properties below:
a) the carrier consists of a low-energy polymer; and
b) the carrier has a structured surface; and thereafter
(B) removing said object from said substrate by pulling said adhesive film at a removal angle of >45° around said edge of said object.

9. The method according to claim 8, wherein the object is an electronics component.

10. An assembly comprising:
a) an object; and
b) a multi-layer adhesive film according to claim 5;
wherein the single-sided auxiliary adhesive tape is adhered between said catch of said adhesive film and an edge of said object.

11. The assembly according to claim 10, wherein the object is an electronics component.
